(19) United States
(12) Patent Application Publication
(10) Pub. No.: US 2016/0094601 A1
(43) Pub. Date: Mar. 31, 2016

(54) METHODS AND APPARATUS TO MEASURE EXPOSURE TO STREAMING MEDIA

(71) Applicant: The Nielsen Company (US), LLC, Schaumburg, IL (US)

(72) Inventor: Jan Besehanic, Tampa, FL (US)

(21) Appl. No.: 14/502,452

(22) Filed: Sep. 30, 2014

(51) Int. Cl. H04L 29/06; H04L 29/08

(52) U.S. Cl. CPC H04L 65/60; H04L 67/32

(57) ABSTRACT

Methods, apparatus, systems and articles of manufacture to measure exposure to streaming media are disclosed. An example method includes accessing media received from a service provider at a media device, the media formatted using a binary format. The media is converted into a text-formatted media. A position of inserted metadata within the text-formatted media is located. The inserted metadata is extracted from the text-formatted media using the located position. The extracted metadata is transmitted to a central facility.

### FIELD OF THE DISCLOSURE

This disclosure relates generally to measuring media exposure, and, more particularly, to methods and apparatus to measure exposure to streaming media.

### BACKGROUND

Streaming enables media to be delivered to and presented by a wide variety of media presentation devices, such as desktop computers, laptop computers, tablet computers, personal digital assistants, smartphones, etc. A significant portion of media (e.g., content and/or advertisements) is presented via streaming to such devices.

### BRIEF DESCRIPTION OF THE DRAWINGS

FIG. 1 is a diagram of an example system for measuring exposure to streaming media.

FIG. 2 is a block diagram of an example implementation of an example HLS stream that may be displayed by the example media monitor of FIG. 1.

FIG. 3 is an example representation of a media file transmitted to the media device by the service provider of FIG. 1.

FIG. 4 is a block diagram of an example implementation of the media monitor of FIG. 1.

FIG. 5 is example Hypertext Markup Language (HTML) code representing a webpage that may be displayed by the example media device of FIG. 1.

FIG. 6 is a flowchart representative of example machine-readable instructions which may be executed to implement the example service provider of FIG. 1

FIG. 7 is a flowchart representative of example machine-readable instructions which may be executed to implement the example media monitor of FIGS. 1 and/or 4.

FIG. 8 is a flowchart representative of example machine-readable instructions which may be executed to implement the example media monitor of FIGS. 1 and/or 4.

FIG. 9 is a block diagram of an example server structured to execute the example machine-readable instructions of FIG. 6 to implement the example service provider of FIG. 1.

FIG. 10 is a block diagram of an example media device structured to execute the example machine-readable instructions of FIGS. 7 and/or 8 to implement the example media monitor of FIGS. 1 and/or 4.

Wherever possible, the same reference numbers will be used throughout the drawing(s) and accompanying written description to refer to the same or like parts.

### DETAILED DESCRIPTION

The use of mobile devices (e.g., smartphones, tablets, MP3 players, etc.) to view media has increased in recent years. Initially, service providers created custom applications (e.g., apps) to display their media. As more types of mobile devices having different software requirements, versions, compatibilities, etc., entered the market, service providers began displaying streaming media in a browser of the mobile device. Consequently, many users view streaming media via the browser of their mobile device. Understanding how users interact with streaming media (e.g., such as by understanding what media is presented, how the media is presented, etc.) provides valuable information to service providers, advertisers, media providers (e.g., providers of content), manufacturers, and/or other entities.

Example methods, apparatus, systems, and articles of manufacture disclosed herein may be used to measure exposure to streaming media. Some such example methods, apparatus, and/or articles of manufacture measure such exposure based on media metadata, user demographics, and/or media device types. Some examples disclosed herein may be used to monitor streaming media transmissions received at client devices such as personal computers, tablets (e.g., an iPad®), portable devices, mobile phones, Internet appliances, and/or any other device capable of playing media. Some example implementations disclosed herein may additionally or alternatively be used to monitor playback of locally stored media in media devices. Example monitoring processes disclosed herein collect media metadata associated with media presented via media devices and associate the metadata with demographics information of users of the media devices. In this manner, detailed exposure metrics are generated based on collected media metadata and associated user demographics. As used herein, the term “metadata” is defined to be data that describes other data. In examples disclosed herein, metadata is used to describe and/or identify media. As such, metadata may be any data in any format that may be used for identifying media.

As used herein, the term “media” includes any type of content and/or advertisement (e.g., audio and/or visual (still or moving) content and/or advertisement) delivered via any type of distribution medium. Thus, media includes television programming, television advertisements, radio programming, radio advertisements, movies, web sites, streaming media, television commercials, radio commercials, Internet ads, etc. Example methods, apparatus, and articles of manufacture disclosed herein monitor media presentations at media devices. Such media devices may include, for example, Internet-enabled televisions, personal computers, Internet-enabled mobile handsets (e.g., a smartphone), video game consoles (e.g., Xbox®, PlayStation®), tablet computers (e.g., an iPad®), digital media players (e.g., a Roku® media player, a Slingbox®, etc.), etc.

Audio watermarking is a technique used to identify media such as television broadcasts, radio broadcasts, advertisements (television and/or radio), downloaded media, streaming media, prepackaged media, etc. Existing audio watermarking techniques identify media by including (e.g., embedding) one or more codes (e.g., one or more watermarks), such as media identifying information and/or an identifier that may be mapped to media identifying information, into a media signal (e.g., into an audio and/or video component of a media signal). In some examples, the audio or video component is selected to have a signal characteristic sufficient to hide the watermark. As used herein, the terms “code” or “watermark” are used interchangeably and are defined to mean any identification information (e.g., an identifier) that may be inserted in, transmitted with, or embedded in media (e.g., a program or advertisement) for the purpose of identifying the media or for another purpose such as tuning (e.g., a packet identifying header). To identify watermarked media, the watermark(s) are extracted and used to access a table of reference watermarks that are mapped to media identifying information.

Unlike media monitoring techniques based on codes and/or watermarks included with and/or embedded in the monitored media, fingerprint or signature-based media monitoring techniques generally use one or more inherent characteristics of the signal(s) representing the monitored media during a monitoring time interval to generate a substantially unique proxy for the media. Such a proxy is referred to as a signature or fingerprint, and can take any form (e.g., a series of digital values, a waveform, etc.) representative of any aspect(s) of the media signal(s)(e.g., the audio and/or video signals forming the media presentation being monitored). A good signature is one that is repeatable when processing the same media presentation, but that is unique relative to other (e.g., different) presentations of other (e.g., different) media. Accordingly, the terms “fingerprint” and “signature” are used interchangeably herein and are defined herein to mean a proxy for identifying media that is generated from one or more inherent characteristics of the media and/or the signal representing the media.

Signature-based media monitoring generally involves determining (e.g., generating and/or collecting) signature(s) representative of a media signal (e.g., an audio signal and/or a video signal) output by a monitored media device and comparing the monitored signature(s) to one or more references signatures corresponding to known (e.g., reference) media. Various comparison criteria, such as a cross-correlation value, a Hamming distance, etc., can be evaluated to determine whether a monitored signature matches a particular reference signature. When a match between the monitored signature and one of the reference signatures is found, the monitored media can be identified as corresponding to the particular reference media represented by the reference signature that matched the monitored signature. Because attributes, such as an identifier of the media, a presentation time, a broadcast channel, etc., are collected for the reference signature, these attributes may then be associated with the monitored media whose monitored signature matched the reference signature. Example systems for identifying media based on codes and/or signatures are long known and were disclosed in Thomas, U.S. Pat. No. 5,481,294, which is hereby incorporated by reference in its entirety.

As discussed above, media presented by a media device has sometimes been monitored by detecting the presence of audio watermarks. However, detection of audio watermarks can sometimes be difficult to implement. Monitoring audio watermarks using a media device is difficult because, for example, the media device may not have a microphone to detect audio watermarks, the media device may not enable programmatic access to an audio buffer, etc. Furthermore, after the audio is detected (e.g., by accessing an audio buffer, by accessing a microphone, etc.), processing the audio to detect the watermark consumes processor resources of the media device, thereby draining a battery of the media device and potentially affecting how a user uses and/or experiences the media device. Affecting how a user uses and/or experiences a media device is undesirable because it may impact the results of the monitoring effort (e.g., by monitoring changed behavior instead of behavior in the absence of monitoring). Moreover, taxing the resources of a media device may adversely affect its performance (e.g., cause slow response times, interfere with media display, and/or otherwise negatively affect the devices operation).

To enable monitoring, monitoring entities embed metadata in media to enable collection of the metadata and generation of media exposure reports. Some systems embed metadata in a closed captioning transport stream, a metadata channel of a transport stream, a separate timed text track, etc. Some such systems provide media devices with monitoring instructions to cause the media devices to return, store, and/or forward the metadata to a remote data collection site. Example systems for embedding metadata into media are described in U.S. patent application Ser. Nos. 13/341,646, 13/341,661, 13/443,596, 13/793,991, 13/445,961, 13/793,974, 13/472,170, 13/767,548, 13/793,959, and 13/778,108, which are incorporated by reference in their entirety.

Different media devices may be implemented with different browsers and/or media presentation functionality. Monitoring instructions to retrieve metadata may function differently on different media devices. Accordingly, some known media monitoring approaches are not cross-platform compatible. For example, while instructions for retrieving metadata from a metadata channel of a transport stream may function properly on a first system (e.g., an Apple iPad), they may not function properly on a second system (e.g., an Android Tablet). Maintaining different sets of instructions and/or ensuring the correct type of instructions are provided to the correct type of device is a very difficult technical problem. Example systems, methods, and apparatus disclosed herein overcome this problem by enabling a single set of monitoring instructions to be operated on multiple different devices and/or browsers. In examples disclosed herein, metadata is included with (e.g., embedded into) media by inserting the metadata formatted as a string into a file containing the media.

In some examples, the media identifying data (e.g., a code, a signature, a watermark, a fingerprint, etc.) having a first format is extracted at a service provider headend or the like from media decoded from a transport stream. In some such examples, the transport stream corresponds to a Moving Picture Experts Group (MPEG) 4 transport stream sent according to a hypertext transfer protocol (HTTP) live streaming (HLS) protocol. An example of media identifying data having the first format is an audio watermark that is embedded in an audio portion of the media. Additionally or alternatively, the media identifying data having the first format may be a video (e.g., image) watermark that is embedded in a video portion of the media. In some examples, the extracted media identifying data having the first format is transcoded into media identifying data having a second format. The media identifying data having the second format may correspond to, for example, metadata represented in a string format, such as an ID3 tag for insertion into a file containing the media.

Some example methods disclosed herein to monitor streaming media include inspecting a media file received at a consumer media device from a service provider. These example methods also include generating media presentation data for reporting to an audience measurement entity. As used herein, media presentation data includes metadata extracted from media (e.g., media identifying data) and/or other parameters related to the media presentation such as, for example, a playback position within the media, a duration of the media, a source of the media (e.g., a universal resource locator (URL) of a service provider, a name of a service provider, a channel, etc.), metadata of the media presenter (e.g., a display size of the media, a volume setting, etc.) a timestamp, a user identifier, and/or device identifier, etc.

In some examples, media presentation data is aggregated to determine ownership and/or usage statistics of media devices, relative rankings of usage and/or ownership of media devices, types of uses of media devices (e.g., whether a device is used for browsing the Internet, streaming media from the Internet, etc.), and/or other types of media device information. In some examples, media presentation data is aggregated to determine audience size(s) of different media, demographics associated with audience(s) of different media, etc. In some other examples, the aggregated device oriented information and the aggregated audience oriented information of the above examples are combined to identify audience sizes, demographics, etc. for media as presented on different type(s) of devices. In examples disclosed herein, media presentation data includes, but is not limited to, media identifying information (e.g., media-identifying metadata, codes, signatures, watermarks, and/or other information that may be used to identify presented media), application usage information (e.g., an identifier of an application, a time and/or duration of use of the application, a rating of the application, etc.), and/or user-identifying information (e.g., demographic information, a user identifier, a panelist identifier, a username, etc.). “Applications” are sometimes referred to as “apps”.

In some disclosed examples, streaming media is delivered to the media device using HTTP Live Streaming (HLS). However, any other past, present, and/or future method of streaming media to the media device may additionally or alternatively be used such as, for example, an HTTP Secure (HTTPS) protocol. HLS transport streams allow media to be transmitted to the media device in short duration segments (e.g., three second segments, five second segments, thirty second segments, etc.). In some disclosed examples, a media device uses a browser to display media received via HLS. To present the media, the example media device presents each sequential segment in sequence. Additionally or alternatively, in some disclosed examples the media device uses a media presenter (e.g., a browser plugin, an app, a framework, an application programming interface (API), etc.) to display media received via HLS.

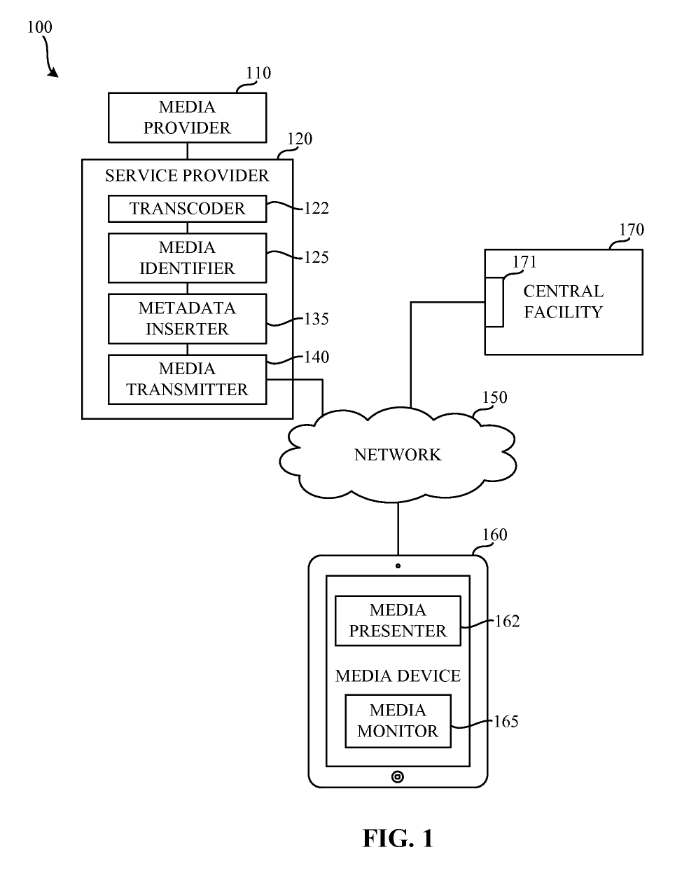

FIG. 1 is a diagram of an example system 100 for measuring exposure to streaming media. The example of FIG. 1 includes a media monitor 165 to monitor media provided by an example media provider 110 via an example network 150 for presentation by a media presenter 162 of an example media device 160. In the example of FIG. 1, an example service provider 120, an example media monitor 165, and an example central facility 170 of an audience measurement entity cooperate to collect media presentation data. While the illustrated example of FIG. 1 discloses an example implementation of the service provider 120, other example implementations of the service provider 120 may additionally or alternatively be used, such as the example implementations disclosed in co-pending U.S. patent application Ser. Nos. 13/341,646, 13/341,661, 13/443,596, 13/793,991, 13/445,961, 13/793,974, 13/472,170, 13/767,548, 13/793,959, and 13/778,108, which are hereby incorporated by reference herein in their entirety.

The media provider 110 of the illustrated example of FIG. 1 corresponds to any one or more media provider(s) capable of providing media for presentation at the media device 160. The media provided by the media provider(s) 110 can be any type of media, such as audio, video, multimedia, etc. Additionally or alternatively, the media can correspond to live (e.g., broadcast) media, stored media (e.g., on-demand content), etc.

The service provider 120 of the illustrated example of FIG. 1 provides media services to the media device 160 via, for example, web pages including links (e.g., hyperlinks, embedded media, etc.) to media provided by the media provider 110. In some examples, the service provider 120 is implemented by a server (i.e., a service provider server) operated by an entity providing media services (e.g., an Internet service provider, a television provider, etc.). In the illustrated example, the service provider 120 modifies the media provided by the media provider 110 prior to transmitting the media to the media device 160. In the illustrated example, the service provider 120 includes an example transcoder 122, an example media identifier 125, an example metadata inserter 135, and an example media transmitter 140.

In the illustrated example, the transcoder 122 employs any appropriate technique(s) to transcode and/or otherwise process the media received from the media provider 110 into a form suitable for streaming (e.g., a streaming format). For example, the transcoder 122 of the illustrated example transcodes the media in accordance with MPEG 4 audio/video compression for use via the HLS protocol. However, any other format may additionally or alternatively be used. In examples disclosed herein, the transcoder 122 transcodes the media into a binary format for transmission to the media device 160. To prepare the media for streaming, in some examples, the transcoder 122 segments the media into smaller portions implemented by MPEG4 files. For example, a thirty second piece of media may be broken into ten segments (MPEG4 files), each being three seconds in length.

The example media identifier 125 of FIG. 1 extracts media identifying data (e.g., signatures, watermarks, etc.) from the media (e.g., from the transcoded media). The media identifier 125 of the illustrated example implements functionality provided by a software development kit (SDK) provided by the Audience Measurement Entity associated with the central facility to extract one or more audio watermarks, one or more video (e.g., image) watermarks, etc., embedded in the audio and/or video of the media. For example, the media may include pulse code modulation (PCM) audio data or other types of audio data, uncompressed video/image data, etc. In the illustrated example, the example media identifier 125 inspects each segment of media to extract the media identifying data. However, in some examples, the media identifying data for the different transcoded segments is the same and thus, media identifying data from one of the segments is used for multiple segments. In some examples, rather than processing the transcoded media, the media identifier 125 processes the media received from the media provider 110 (e.g., prior to and/or in parallel with transcoding).

The example media identifier 125 of FIG. 1 determines (e.g., derives, decodes, converts, etc.) the media identifying data (e.g., such as media identifying metadata, source identifying information, etc.) included in or identified by a watermark embedded in the media and converts this media identifying data into a format for insertion in an ID3 tag and/or other metadata format for transmission as metadata inserted into the media. In some examples, the watermark itself is included in the ID3 tag (e.g., without undergoing any modification). In some examples, the metadata is not included in the watermark embedded in the media but, rather, is derived based on a look-up of data based on the watermark. For example, the example media identifier 125 may query a lookup table (e.g., a lookup table stored at the service provider 120, a lookup table stored at the central facility 170, etc.) to determine the metadata to be packaged with the media.

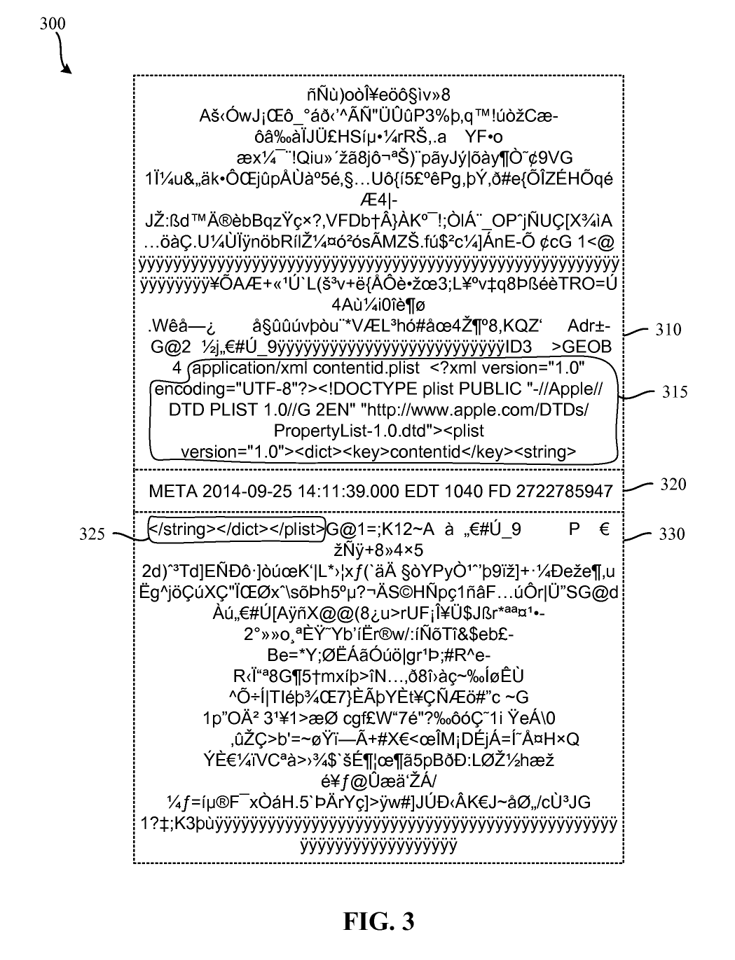

In the illustrated example, the metadata inserter 135 inserts the metadata determined by the media identifier 125 into one or more of the media segments. In the illustrated example, the metadata inserter 135 converts the metadata to a binary format for insertion in each respective media segment. In the illustrated example, the metadata inserter 135 prepends a metadata start section to the metadata and appends a metadata stop section to the metadata. Example metadata start and stop sections are shown in the illustrated example of FIG. 3. The metadata start and stop sections prevent the inserted metadata from causing the media presenter 162 to malfunction when presenting the media. When presenting media, media presenters, such as the example media presenter 162, read a media file and render the media based on data in the media file. When the media file includes additional information that is not expected by the media presenter 162, the media presenter 162 might malfunction (e.g., crash, stop presenting the media, etc.). Using the metadata start and stop sections places the metadata into a format that is expected by the media presenter 162, thereby reducing the likelihood that the media presenter 162 might malfunction.

In the illustrated example, the metadata inserter 135 inserts metadata corresponding to the media identifying data into the segmented media files (e.g., the MPEG4 files) that are to stream the media in accordance with the HLS or other appropriate streaming protocol. Accordingly, when the media segments are transmitted to the media device 160 for presentation, the metadata is included in a format that is readable by JavaScript instructions and, in some examples, does not require interaction with a media presenter for retrieval of metadata.

The media transmitter 140 employs any appropriate technique(s) to select and/or stream the media segments to a requesting device, such as the media device 160. For example, the media transmitter 140 of the illustrated example selects one or more media segments in response to a request for the one or more segments by the media device 160. The media transmitter 140 then streams the media to the media device 160 via the network 150 using HLS or any other streaming protocol. In some examples, when transmitting the media to the media device 160, the media transmitter 140 includes instructions for extracting the metadata from the media. The instructions may be located within a webpage transmitted to the media device 160. Moreover, the instructions may be transmitted in a separate instruction document transmitted in association with the webpage to the media device 160.

In some examples, the media identifier 125, the transcoder 122, and/or the metadata inserter 135 prepare media for streaming regardless of whether (e.g., prior to) a request is received from the client device 160. In such examples, the already-prepared media is stored in a data store of the service provider 120 (e.g., such as in a flash memory, magnetic media, optical media, etc.). In such examples, the media transmitter 140 prepares a transport stream for streaming the already-prepared media to the client device 160 when a request is received from the client device 160. In other examples, the media identifier 125, the transcoder 122, and/or the metadata inserter 135 prepare the media for streaming in response to a request received from the client device 160.

The example network 150 of the illustrated example is the Internet. Additionally or alternatively, any other network(s) communicatively linking the service provider 120 and the client device such as, for example, a private network, a local area network (LAN), a virtual private network (VPN), etc. may be used. The network 150 may comprise any number of public and/or private networks using any type(s) of networking protocol(s).

The media device 160 of the illustrated example of FIG. 1 is a computing device that is capable of presenting streaming media provided by the media transmitter 140 via the network 150. The media device 160 may be, for example, a tablet, a desktop computer, a laptop computer, a mobile computing device, a television, a smart phone, a mobile phone, an Apple® iPad®, an Apple® iPhone®, an Apple® iPod®, an Android™ powered computing device, a Palm® webOS® computing device, etc. In the illustrated example, the media device 160 includes a media presenter 162 and a media monitor 165. In the illustrated example, the media presenter 162 is implemented by a media player (e.g., Apple QuickTime, a browser plugin, a local application, etc.) that presents streaming media provided by the media transmitter 140 using any past, present, or future streaming protocol(s). For example, the example media presenter 162 may additionally or alternatively be implemented in Adobe® Flash® (e.g., provided in a SWF file), may be implemented in hypertext markup language (HTML) version 5 (HTML5), may be implemented in Google® Chromium®, may be implemented according to the Open Source Media Framework (OSMF), may be implemented according to a device or operating system provider's media player application programming interface (API), may be implemented on a device or operating system provider's media player framework (e.g., the Apple® iOS® MPMoviePlayer software), etc., or any combination thereof.

In the illustrated example, the media monitor 165 interacts with the media presenter 162 to identify the metadata. The example media monitor 165 identifies media presentation data. As noted above, media presentation data includes metadata extracted from media (e.g., media identifying data) as well as other parameters related to the media presentation such as, for example, a playback position within the media, a duration of the media, a source of the media (e.g., a universal resource locator (URL) of a service provider, a name of a service provider, a channel, etc.), a timestamp, a user and/or device identifier, etc. In the illustrated example, the media monitor 165 reports media presentation data to the central facility 170. While a single media device 160 is illustrated in FIG. 1 for simplicity, in most implementations many media devices 160 will be present. Thus, any number and/or type(s) of media devices may be used.

The central facility 170 of the audience measurement entity of the illustrated example of FIG. 1 includes an interface to receive reported metering information (e.g., metadata) from the media monitor 165 of the media device 160 via the network 150. In some examples, the central facility 170 is implemented by a server (i.e., an audience measurement entity server) operated by the audience measurement entity. In examples disclosed herein, the audience measurement entity (AME) is a neutral third party (such as The Nielsen Company (US), LLC) who does not source, create, and/or distribute media and can, thus, provide unbiased ratings and/or other media monitoring statistics. In the illustrated example, the central facility 170 includes an HTTP interface 171 to receive HTTP requests that include the metering information. Additionally or alternatively, any other method(s) to receive metering information may be used such as, for example, an HTTP Secure protocol (HTTPS), a file transfer protocol (FTP), a secure file transfer protocol (SFTP), etc. In the illustrated example, the central facility 170 stores and analyzes metering information received from a plurality of different client devices. For example, the central facility 170 may sort and/or group metering information by media provider 110 (e.g., by grouping all media identifying data associated with a particular media provider 110). Any other processing of metering information may additionally or alternatively be performed.

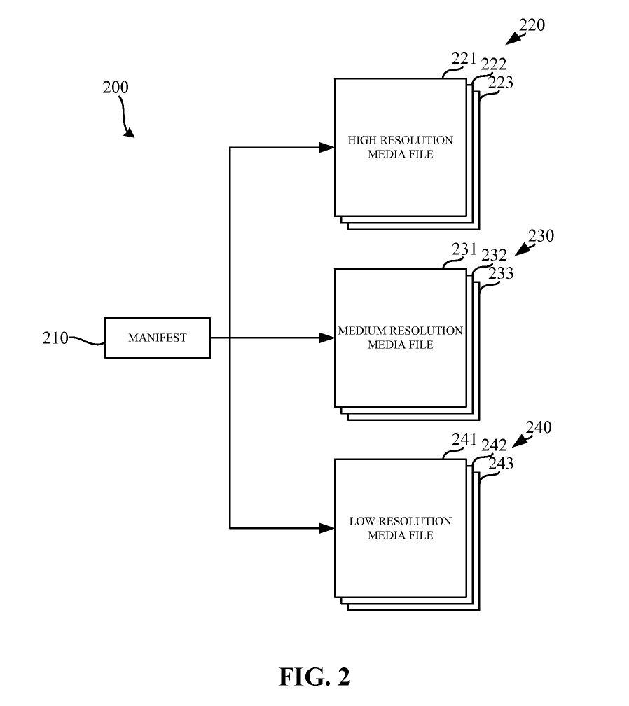

FIG. 2 is a block diagram of an example implementation of an example HLS stream that may be displayed by the example media monitor of FIG. 1. In the illustrated example of FIG. 2, the HLS stream 200 includes a manifest 210 and three sets of media files (e.g., transport streams and/or transport stream files). In the illustrated example, the manifest 210 is an .m3u8 file that describes the available media files to the media device. However, any other past, present, and/or future file format may additionally or alternatively be used. In the illustrated example, the media device retrieves the manifest 210 in response to an instruction to display an HLS element (e.g., a video tag within a webpage).

HLS is an adaptive format, in that, although multiple devices retrieve the same manifest 210, different media files and/or transport streams may be displayed depending on one or more factors. For example, devices having different bandwidth availabilities (e.g., a high speed Internet connection, a low speed Internet connection, etc.) and/or different display abilities (e.g., a small size screen such as a cellular phone, a medium size screen such as a tablet and/or a laptop computer, a large size screen such as a television, etc.) select an appropriate transport stream for their display and/or bandwidth abilities. In some examples, a cellular phone having a small screen and limited bandwidth uses a low-resolution transport stream. Alternatively, in some examples, a television having a large screen and a high speed Internet connection uses a high-resolution transport stream. As the abilities of the device change (e.g., the device moves from a high-speed Internet connection to a low speed Internet connection) the device may switch to a different transport stream.

In the illustrated example of FIG. 2, a set of high-resolution media files 220, a set of medium resolution media files 230, and a set of low-resolution media files 240 are shown. In the illustrated example, each media file 221, 222, 223, 231, 232, 233, 241, 242, 243 represents a segment of the associated media (e.g., five seconds, ten seconds, thirty seconds, one minute, etc.). Accordingly, a first high resolution media file 261 corresponds to a first segment of the media, a second high resolution media file 622 corresponds to a segment portion of the media, a third high resolution media file 623 corresponds to a third segment of the media. Likewise, a first medium resolution media file 631 corresponds to the first segment of the media, a second medium resolution media file 232 corresponds to the second portion of the media, and a third medium resolution media file 633 corresponds to the third portion of the media. In addition, a first low resolution media file 641 corresponds to the first portion of the media, a second low resolution media file 642 corresponds to the second portion of the media, and a third low resolution media file 643 to the third portion of the media. Although three media files are shown in the illustrated example of FIG. 2 for each resolution (e.g., each set of media files), any number of media files representing any number of corresponding segments of the media may additionally or alternatively be used. In the illustrated example, each media file 221, 222, 223, 231, 232, 233, 241, 242, 243 includes metadata inserted by the metadata inserter 153. However, in some examples, less than all of the media files include the inserted metadata. For example, the metadata may be included in the every other media file, only in the first media file, etc.

FIG. 3 is an example representation of a media file 300 transmitted to the media device 160 by the service provider 120 of FIG. 1. In the illustrated example, the example media file 300 is shown using a string format for enhanced clarity. However, in practice, the media file 300 is typically formatted using a binary format. In the illustrated example of FIG. 3, the example media file 300 includes a first section 310, a metadata section 320, and a second section 330. In the illustrated example, the metadata inserter 135 inserts the metadata section 320 between the first section 310 and the second section 330. However, the metadata section may be inserted in any other fashion (e.g., any other place). For example, the example metadata section may be prepended or appended to the media. In the illustrated example, the metadata section 320 is formatted using an ID3 format. However, any other metadata format may additionally or alternatively be used.

In the illustrated example of FIG. 3, the metadata inserter 135 modifies the first section 310 to include a metadata start section 315. The example metadata inserter 135 modifies the second section 330 to include a metadata stop section 325. The metadata start section 315 and the metadata stop section 325 prevent the inserted metadata 320 from causing the media presenter 162 to malfunction when presenting the media. When presenting the media, the example media presenter 162 reads a media file and renders the media based on data in the media file. When the media file includes additional information that is not expected by the media presenter 162, the media presenter 162 might malfunction (e.g., crash, stop presenting the media, etc.). Using the metadata start and stop sections places the metadata into a format that is expected by the media presenter 162 (e.g., in a metadata section in an expected metadata format), thereby reducing the likelihood that the media presenter 162 might malfunction.

In some examples, the metadata section 320 may include the metadata start section 315 and/or the metadata stop section 325. In the illustrated example, the metadata start section 315 and the metadata stop section 325 form a property list (.plist) around the metadata. However, any other format of the metadata start section 315 and/or the metadata stop section 325 may additionally or alternatively be used. The format of the metadata start section 315 and/or the metadata stop section 325 may depend on the type of media file being played and/or on the media presenter that is presenting the media file. For example, rather than implementing a metadata section, a comment section may be implemented.

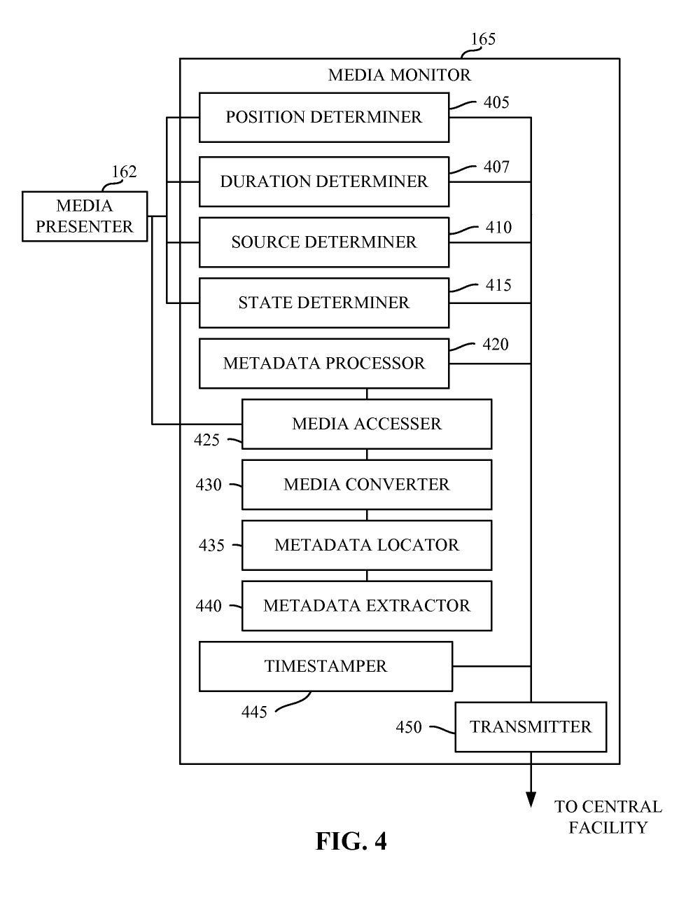

FIG. 4 is a block diagram of an example implementation of the media monitor 165 of FIG. 1. The example media monitor 165 of FIG. 4 includes a position determiner 405, a duration determiner 407, a source determiner 410, a state determiner 415, a metadata processor 420, a media accesser 425, a media converter 430, a metadata locator 435, a metadata extractor 440, a timestamper 445, and a transmitter 450.

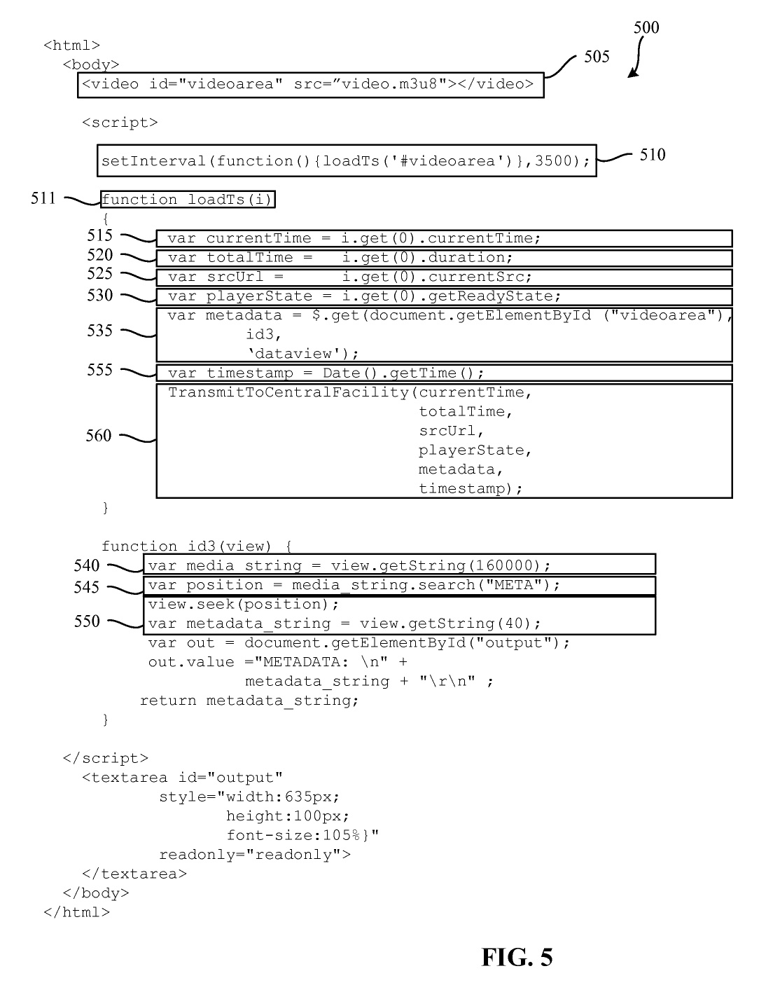

The example position determiner 405 determines a current position of media presentation within media. As used herein, the current position represents a temporal offset (e.g., a time) from a start of the media (e.g., zero seconds, five seconds, ten seconds, etc.). In the illustrated example, the current position is measured in seconds. However, any other measure of time may additionally or alternatively be used, such as, for example, minutes, milliseconds, hours, etc. Moreover, any way of identifying a current position within a media presentation may additionally or alternatively be used, such as, for example, a video frame identifier of the media, etc. In particular, in the illustrated example, the example position determiner 405 identifies the current position by interacting with the media presenter 162. In the illustrated example, the position determiner 405 is implemented by a JavaScript instruction(s) to retrieve the current position from the media presenter 162. In the illustrated example, the JavaScript instruction(s) are transmitted to the media device 160 as part of a webpage that includes an instruction (e.g., a link, a Hypertext Markup Language (HTML) tag, etc.) instructing the media device to display the media. An example webpage including JavaScript instructions to implement the example position determiner 405 is shown in FIG. 5. In the illustrated example, the media presenter 162 presents an Application Programming Interface (API) that enables requests for the current position of the media to be serviced. In the illustrated example, the API includes a “currentTime” function which, when called, responds to the example position determiner 405 with the current position of the media. To service the request, the example media presenter 162 determines a position within the media by, for example, detecting a time associated with a currently presented frame of the media. However, any other way of identifying a current position of media presentation within media may additionally or alternatively be used.

The example duration determiner 407 of this example determines a duration of the media. In the illustrated example, the duration determiner 407 is implemented by a JavaScript instruction which, when executed, queries the media presenter 162 for the duration of the media. In the illustrated example, the JavaScript instruction(s) are transmitted to the media device 160 as part of a webpage that includes an instruction (e.g., a link, a Hypertext Markup Language (HTML) tag, etc.) instructing the media device to display the media. An example webpage including JavaScript instructions to implement the example duration determiner 407 is shown in FIG. 5. In the illustrated example, the API provided by the media presenter 162 includes a “duration” function which, when called, responds to the example duration determiner 407 with the duration of the media. To service the request for the duration, the example media presenter 162 determines a duration of the media by, for example, detecting a time associated with a last frame of the media. However, any other approach to identifying a duration of media may additionally or alternatively be used such as, for example, processing a screenshot of the media presenter to identify a duration text (e.g., 5:06, representing media that is five minutes and six seconds in duration).

The example source determiner 410 of the illustrated example of FIG. 4 interacts with the example media presenter 162 to identify a source of the media (e.g., a universal resource locator (URL) from which the media was retrieved). In the illustrated example, the source of the media is identified by a URL. However, the source may additionally or alternatively be identified in any other way (e.g., a name of the service provider 120, a name of the media provider 110, etc.). In the illustrated example, the example source determiner 410 is implemented by a JavaScript instruction which, when executed, queries the media presenter 162 for the source URL. In the illustrated example, the JavaScript instruction(s) are transmitted to the media device 160 as part of a webpage that includes an instruction (e.g., a link, a Hypertext Markup Language (HTML) tag, etc.) instructing the media device to display the media. An example webpage including JavaScript instructions to implement the example source determiner 410 is shown in FIG. 5. In the illustrated example, the API provided by the media presenter 162 includes a “currentSrc” function which, when called, responds to the example source determiner 410 with the source of the media. To service the request for the source, the example media presenter 162 determines a source of the media by, for example, detecting a source URL from which the media was retrieved. In some examples, rather than interacting with the media presenter 162 (e.g., a QuickTime plugin of a browser), the example source determiner 410 implements JavaScript instructions to read a source of a media element of within a webpage (e.g., a source field of a video tag within a hypertext markup language (HTML) webpage). In such an example, the JavaScript instructions may retrieve the source of the media by inspecting a document object model (DOM) object created by the browser when rendering the webpage.

The example state determiner 415 of the illustrated example of FIG. 4 interacts with the example media presenter 162 to identify a state of the media presentation. As described herein, the state of the media presentation represents whether the media presentation is actively being played, whether the media presentation is paused, whether the media presentation has stopped, etc. In the illustrated example, the example state determiner 415 is implemented by a JavaScript instruction which, when executed, queries the media presenter 162 for the state of the media presentation. In the illustrated example, the JavaScript instruction(s) are transmitted to the media device 160 as part of a webpage that includes an instruction (e.g., a link, a Hypertext Markup Language (HTML) tag, etc.) instructing the media device to display the media. An example webpage including JavaScript instructions to implement the example state determiner 415 is shown in FIG. 5. In the illustrated example, the API provided by the media presenter 162 includes a “getReadyState” function which, when called, responds to the example state determiner 415 with the state of the media presentation. To service the request for the state, the example media presenter 162 determines its current mode of operation (e.g., playing media, paused, fast forwarding, etc.). However, any other approach may additionally or alternatively be used such as, for example, processing an image of the media presenter to, for example, detect a presence of a play icon, a presence of a pause icon, etc.

The example metadata processor 420 of the illustrated example of FIG. 4 determines whether media presentation data should be gathered. If media presentation data should be gathered, the example metadata processor 420 instructs the example position determiner 405, the example source determiner 410, the example state determiner 415, the example media accesser 425, the example media converter 430, the example metadata locator 435, the example metadata extractor 440, and/or the example timestamper 445 to gather the media presentation data. In the illustrated example, the metadata processor 420 operates upon loading of the media (e.g., a webpage) by the media device 160 to collect the media presentation data. Moreover, the metadata processor 420 waits a threshold period of time before gathering subsequent media presentation data. As such, media that is loaded by a media device for presentation to a user, but that has not yet been presented (e.g., the user has not clicked a play button) may be monitored. That is, media that is queued for presentation may be detected regardless of whether it has been presented. Some other known systems monitor media presentation events (e.g., a user presses the start button, a frame of a video is advanced, the user presses the pause button, etc.) The approach disclosed herein of collecting media presentation data upon loading of the media is beneficial over such known systems because the approach disclosed herein enables detection of media that is not yet presented, as compared to detecting media only after the presentation begins (e.g., during presentation). This is useful because, for example, it enables monitoring of media that was available for presentation to a user, but which the user does not select for presentation. This provides insights into user choices.

The example media accesser 425 of the illustrated example of FIG. 4 interacts with the media presenter 162 to retrieve a copy of the media presented by the media presenter 162. In the illustrated example, the media accesser 425 accesses the media from a buffer of the media presenter 162 by transmitting a request to the media presenter 162 for access to the buffer. When access is provided, the example media accesser 425 is permitted to read memory locations of the media device 160 allocated to the media presenter 162. In some other examples, the media presenter 162 reads the memory locations on behalf of the media accesser 425 and responds to the request with the data contained in the buffer. However, in the event that the buffer is not accessible, the example media accesser 425 may, in some examples, re-request a copy of the media from the source (e.g., the source URL) of the media identified by the source determiner 410. In such an example, the media may be downloaded twice from the service provider 120 to the media device 160 (e.g., once for use by the media presenter 162, and once for use by the media accesser 425). In some examples, the example media accesser 425 determines if metadata is already known for the media, to thereby avoid instances of multiply downloading the media. In some examples, rather than downloading the media a second time, the media accesser causes previously identified metadata to be used. In some examples, previously identified metadata may be used when it is determined to be current (e.g., identified within a past threshold time such as within the past ten seconds). However, any other approach to determining whether the media should be re-downloaded may additionally or alternatively be used such as, for example, by determining whether there is sufficient bandwidth to re-download the media without adversely affecting the media presentation.

The example media converter 430 of the illustrated example of FIG. 4 converts media accessed by the media accesser 425 into a string representation. In the illustrated example, the media accesser 425 accesses the media in a binary format. However, the metadata embedded in the media is embedded in a text (e.g., string) format. As such, in the illustrated example, the example media converter 430 converts the media from a binary format to a text format. In the illustrated example, the media converter 430 converts the binary data into a text format using an American Standard Code for Information Exchange (ASCII) format. However, any other past, present, or future format may additionally or alternatively be used.

The example metadata locator 435 of the illustrated example inspects the text-formatted media converted by the media converter 430. In the illustrated example, the example metadata locator 435 inspects the text-formatted media for a start location of a metadata tag. In the illustrated example, the start location of the metadata tag represents a character within the text-formatted media where the metadata can be found. Referring to FIG. 3, the example metadata locator 435 inspects the media for the characters “META” as indication of the beginning of the metadata tag (e.g., the beginning of the metadata section 320). However, any other approach may additionally or alternatively be used such as, for example, a different marker than “META” may be used, the metadata locator 435 may inspect the media to identify the metadata start section 315 and/or the metadata stop section 325, the metadata locator 435 may use pattern matching to identify text that matches an expected format of the metadata (e.g., an ID3 tag format).

The example metadata extractor 440 of the illustrated example of FIG. 4 extracts the metadata from the converted media based on the start location of the metadata identified by the metadata locator 435. In the illustrated example, the metadata is a fixed length (e.g., forty characters). As such, the example metadata extractor 440 of FIG. 4 extracts a string from the metadata starting from the start location and matching the fixed length of the metadata (e.g., forty characters). However, in some examples, the metadata is a variable length. In some examples, the example metadata extractor 440 determines a length of the metadata and extracts the metadata based on the identified length. For example, the example metadata extractor 440 may use a regular expression to detect variable length metadata. In some examples, the example metadata may include a length value indicating the length of the metadata which, when used by metadata extractor 440 results in extraction of the metadata using the proper variable length.

The example timestamper 445 of the illustrated example of FIG. 4 generates a timestamp indicative of a date and/or time that the media presentation data was gathered. Timestamping (e.g., determining a time that an event occurred) enables accurate identification and/or correlation of media that was presented and/or the time that it was presented to the user(s) present near and/or operating the media device. In the illustrated example, the timestamper 445 determines the date and/or time using a clock of the media device 160. However, in some examples, the timestamper 445 determines the data and/or time by requesting the date and/or time from an external time source, such as a National Institute of Standards and Technology (NIST) Internet Time Service (ITS) server. However, any other approach to determining a timestamp may additionally or alternatively be used.

The example transmitter 450 of the illustrated example of FIG. 4 transmits the media presentation data to the central facility via, for example, the Internet. As noted above, the media presentation data includes the metadata extracted from the media as well as other parameters related to the media presentation such as, for example, the playback position within the media, the duration of the media, the source of the media, a timestamp, a user and/or device identifier, etc.

In the illustrated example, the media presentation data is transmitted to the central facility using a Hypertext Transfer Protocol (HTTP) Post request. However, any other method of transmitting data and/or metadata may additionally or alternatively be used. Because, in the illustrated example, an HTTP request is used, the transmitter 450 may include cookie data that identifies a user and/or a device that is transmitting the media presentation data (assuming the transmission is to an Internet domain that has set such a cookie). As such, the central facility 170 can identify the user and/or the device as associated with the media presentation. In some examples, the users are panelists and the cookie data that includes the user and/or device identifier is set by the central facility 170 to enable instances of monitored media presentation data to be associated with the panelist. However, in some other examples, the users are not panelists and the demographic information is determined via other approaches, such as those described in Mazumdar, U.S. Pat. No. 8,370,489, which is hereby incorporated by reference in its entirety.

While in the illustrated example an HTTP Post request is used to convey the media presentation data to the central facility 170, any other approach to transmitting data may additionally or alternatively be used such as, for example, a file transfer protocol (FTP), an HTTP Get request, Asynchronous JavaScript and extensible markup language (XML) (AJAX), etc. In some examples, the media presentation data is not transmitted to the central facility 170. Additionally or alternatively, the media presentation data may be transmitted to a display object of the client device 160 for display to a user. In the illustrated example, the media presentation data is transmitted in near real-time (e.g., streamed) to the central facility 170. As used herein, near real-time transmission is defined to be transmission of data (e.g., the media presentation data) within a short time duration (e.g., one minute) of the identification, generation, and/or detection of the data. However, in some examples, the media presentation data may be stored (e.g., cached, buffered, etc.) for a period of time before being transmitted to the central facility 170.

FIG. 5 illustrates example Hypertext Markup Language (HTML) instructions 500 representing a webpage that may be displayed by the example media device 160 of FIG. 1. In the illustrated example, an example video element of block 505 instantiates the media presenter 162. In the illustrated example, the media presenter 162 is instantiated with a media source having a universal resource indicator (URI) and an identifier of the video tag. However, the example video element of block 505 may be instantiated with any other information such as, for example, a height and width of the video, a display type of the video, etc.

In the illustrated example of FIG. 5, a JavaScript setInterval instruction (block 510) is used to cause the function “LoadTs” (block 511) to operate on the video element of block 505 at an interval of thirty five hundred milliseconds (i.e., three and a half seconds). However, any other interval may additionally or alternatively be used such as, for example, one second, ten seconds, thirty seconds, etc.

When the “LoadTs” function (block 511) is called, the example position determiner 405 identifies a current time and/or position within the media (block 515). In the illustrated example, the instruction of block 515 implements the example position determiner 405 and causes a request for the current position within the media to be transmitted to the media presenter 162 that is displaying the video element of block 505. The media presenter 162 responds by determining a time associated with a frame of the media that is currently presented and providing the time to the example position determiner 405.

The example duration determiner 407 identifies a duration of the media (block 520). In the illustrated example, the instruction of block 520 implements the example position determiner 407 and causes a request for the duration of the media to be transmitted to the media presenter 162 that is displaying the video element of block 505. The media presenter 162 responds by determining a time associated with a final frame of the media, and providing the time to the example duration determiner 407.

The example source determiner 410 identifies a source of the media (block 525). In the illustrated example, the instruction of block 525 implements the example source determiner 410 and causes a request for a source universal resource locator (URL) of the media to be transmitted to the media presenter 162 that is displaying the video element of block 505. In the illustrated example, the media presenter responds to the request by performing a lookup of the source URL of the media it is presenting and providing the source URL to the example source determiner 410. However, in some examples, the source determiner 410 may directly inspect the video element of block 505 to identify the source of the media.

The example state determiner 415 identifies a state of the media presenter 162 (block 530). In the illustrated example, the instruction of block 530 implements the example state determiner 415 and causes a request for a current state of the media (e.g., playing, not playing, fast-forwarding, etc.) to be transmitted to the media presenter 162 that is displaying the video element of block 505. In the illustrated example, the example media presenter 162 responds to the request by determining the current state (e.g., mode of operation) of the media presenter 162 and providing the state to the example state determiner 415. However, any other approach to identifying a state of a media presentation may additionally or alternatively be used such as, for example, using image processing techniques to identify whether a play button or a pause button is displayed as part of the video element of block 505. Example systems for identifying a state of a media presentation are disclosed in co-pending U.S. patent application Ser. Nos. 12/100,264 and 12/240,756, which are hereby incorporated by reference in their entirety.

The example media accesser 425 accesses the media by transmitting a request to the media presenter 162 for access to a media buffer. When access is provided, the example media accesser 425 is permitted to read memory locations of the media device 160 allocated to the media presenter 162. In some other examples, the media presenter 162 reads the memory locations on behalf of the media accesser 425 and responds to a request for access to the media with the data contained in the media buffer. The example media accesser 425 instructs the media converter 430, the metadata locator 435, and/or the metadata extractor to determine the metadata (block 535). In the illustrated example, a dataview is used to access the media from the media presenter 162. A dataview is a JavaScript view that provides a low-level interface for reading data from and writing data to a buffer. However, any other approach to accessing the media may additionally or alternatively be used. In the illustrated example, the dataview represents a binary version of the media. The example media converter 430 converts the binary version of the media to a text format (block 540). For example, if the media has a length of two hundred thousand bits, the example media converter 430 may convert the media to a text format using an American Standard Code for Information Interchange (ASCII) eight bit character encoding scheme to result in a string having twenty five thousand characters. However, in some examples, the example media converter 430 converts a part of the media because, for example, it is assumed that the metadata section is within a particular section of the media. For example, the example media converter 430 may convert the first one hundred and sixty thousand bits (e.g., out of two hundred thousand bits) of the binary version of the media to the text format, resulting in a string having twenty thousand characters of eight bits in length. However, any other conversion technique, character encoding schema, and/or text format may additionally or alternatively be used.

The example metadata locator 435 searches through the media to identify the start location of the metadata. (block 545). In the illustrated example, the instructions of block 545 cause the example metadata locator 435 to search for the characters “META” as an indication of the start of the metadata. The example metadata extractor 440 extracts the metadata from the converted media using the identified start location. (block 550). In the illustrated example, the instructions of block 550 cause the metadata extractor to seeks to the identified start location of the metadata within the media, and extract the next forty characters. However, any other approach to extracting metadata may additionally or alternatively be used. For example, pattern recognition (e.g., a regular expression) may be used to extract the metadata. Moreover, while in the illustrated example, the metadata has a fixed length of forty characters, any other length of metadata may additionally or alternatively be used. Furthermore, the metadata may not be a fixed length and may, instead be a variable length. Moreover, the start identifier “META” may be replaced with any other descriptor.

The example timestamper 445 determines a current time indicative of a date and/or time that the media presentation data was gathered. (block 555). The example transmitter 450 then transmits the media presentation data (e.g., the current time, the duration, the source location, the media presentation state, the metadata, the timestamp, etc.) to the central facility. (block 560). In the illustrated example, the example instructions of block 560 cause the transmitter 450 to transmit the media presentation data using an HTTP request. The example transmitter 450 includes a user and/or device identifier in a header of the HTTP request to identify a user of the media device 160 and/or the media device 160 itself. In some examples, the example transmitter 450 embeds the user and/or device identifier in the media presentation data. In the illustrated example, the example media presentation data is transmitted in a JavaScript Object Notation (JSON) format. The JSON format is a data structure format that is used for data interchanging and results in organized data that is easy to parse when transmitted to the central facility 170. However, any other format may additionally or alternatively be used.

While an example manner of implementing the example service provider 120 is illustrated in FIG. 1, and an example manner of implementing the example media monitor 165 of FIG. 1 is illustrated in FIG. 4, one or more of the elements, processes and/or devices illustrated in FIGS. 1 and/or 4 may be combined, divided, re-arranged, omitted, eliminated and/or implemented in any other way. Further, the example transcoder 122, the example media identifier 125, the example metadata inserter 135, the example media transmitter 140, and/or, more generally, the example service provider 120 of FIG. 1, and/or the example position determiner 405, the example duration determiner 407, the example source determiner 410, the example state determiner 415, the example metadata processor 420, the example media accesser 425, the example media converter 430, the example metadata locator 435, the example metadata extractor 440, the example timestamper 445, the example transmitter 450, and/or, more generally, the example media monitor 165 of FIGS. 1 and/or 4 may be implemented by hardware, software, firmware and/or any combination of hardware, software and/or firmware. Thus, for example, any of the example transcoder 122, the example media identifier 125, the example metadata inserter 135, the example media transmitter 140, and/or, more generally, the example service provider 120 of FIG. 1, and/or the example position determiner 405, the example duration determiner 407, the example source determiner 410, the example state determiner 415, the example metadata processor 420, the example media accesser 425, the example media converter 430, the example metadata locator 435, the example metadata extractor 440, the example timestamper 445, the example transmitter 450, and/or, more generally, the example media monitor 165 of FIGS. 1 and/or 4 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s) (e.g., a field programmable gate array (FPGA)). When reading any of the apparatus or system claims of this patent to cover a purely software and/or firmware implementation, at least one of the example transcoder 122, the example media identifier 125, the example metadata inserter 135, the example media transmitter 140, and/or, more generally, the example service provider 120 of FIG. 1, and/or the example position determiner 405, the example duration determiner 407, the example source determiner 410, the example state determiner 415, the example metadata processor 420, the example media accesser 425, the example media converter 430, the example metadata locator 435, the example metadata extractor 440, the example timestamper 445, the example transmitter 450, and/or, more generally, the example media monitor 165 of FIGS. 1 and/or 4 is/are hereby expressly defined to include a tangible computer readable storage device or storage disk such as a memory, a digital versatile disk (DVD), a compact disk (CD), a Blu-ray disk, etc. storing the software and/or firmware. Further still, the example service provider 120 of FIG. 1 and/or the example media monitor 165 of FIGS. 1 and/or 4 may include one or more elements, processes and/or devices in addition to, or instead of, those illustrated in FIGS. 1 and/or 4, and/or may include more than one of any or all of the illustrated elements, processes and devices.

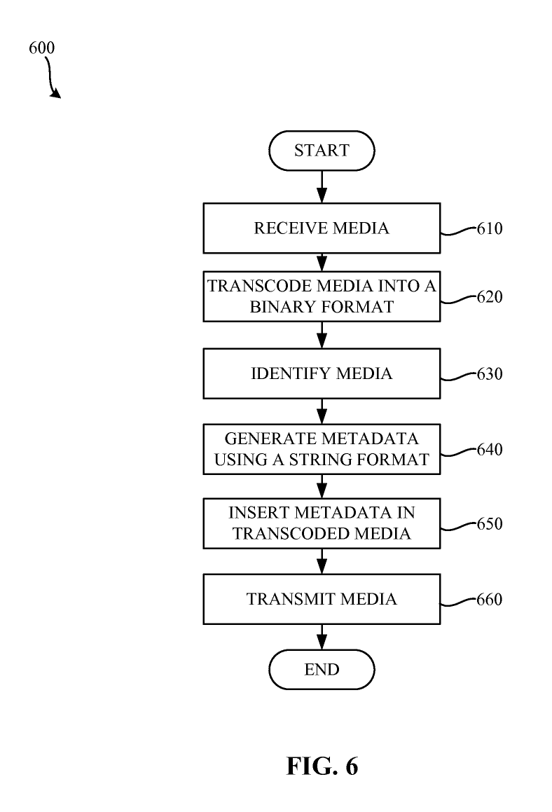

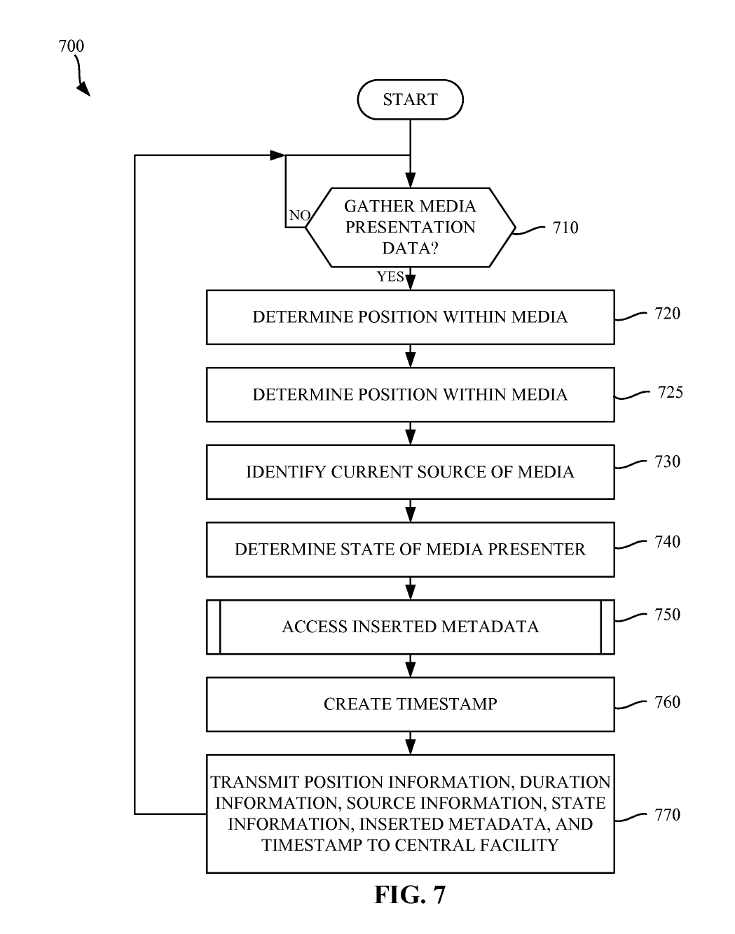

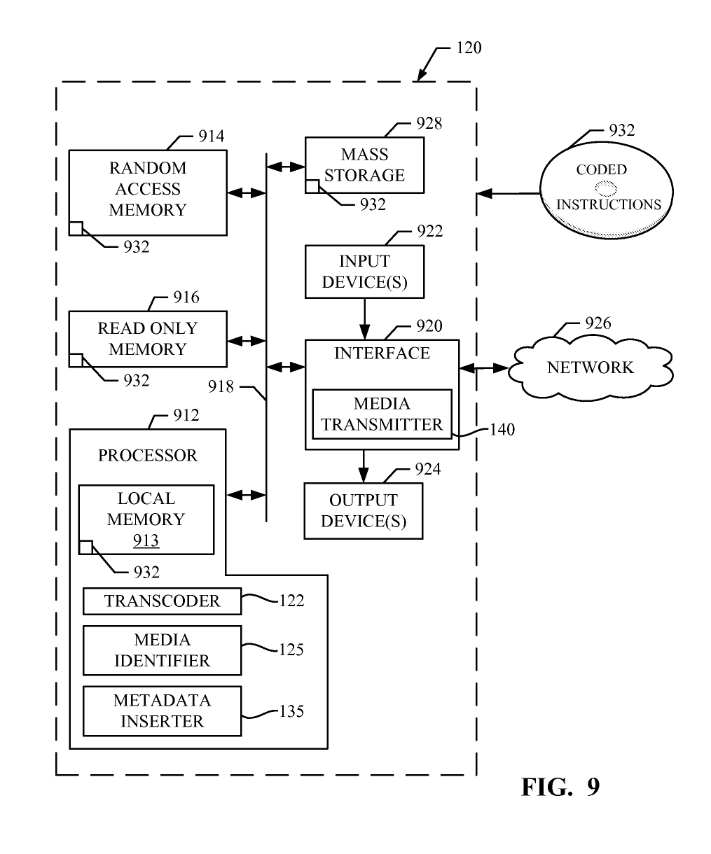

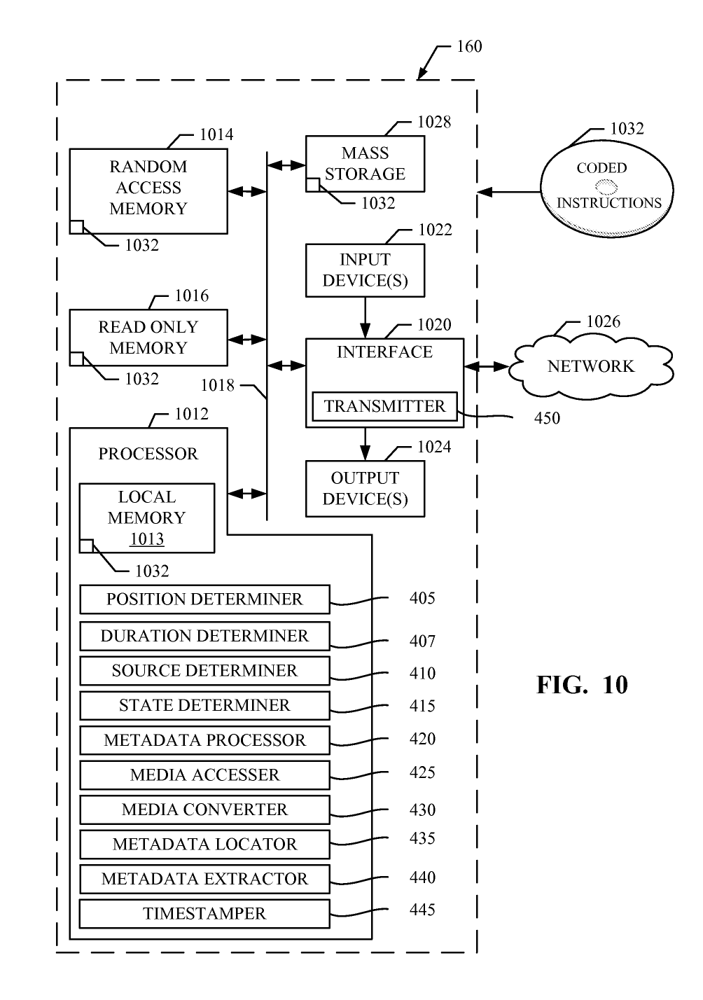

A flowchart representative of example machine readable instructions for implementing the example service provider of FIG. 1 is shown in FIG. 6. Flowcharts representative of example machine readable instructions for implementing the example media monitor 165 of FIGS. 1 and/or 4 are shown in FIGS. 7 and/or 8. In these examples, the machine readable instructions comprise a program(s) for execution by a processor such as the processor 912 shown in the example processor platform discussed below in connection with FIG. 9, and/or the processor 1012 shown in the example processor platform discussed below in connection with FIG. 10. The program may be embodied in software stored on a tangible computer readable storage medium such as a CD-ROM, a floppy disk, a hard drive, a digital versatile disk (DVD), a Blu-ray disk, or a memory associated with the processor 912 and/or 1012, but the entire program and/or parts thereof could alternatively be executed by a device other than the processor 912 and/or 1012, and/or embodied in firmware or dedicated hardware. Further, although the example program is described with reference to the flowchart illustrated in FIGS. 6, 7, and/or 8, many other methods of implementing the example service provider 120 and/or the example media monitor 165 may alternatively be used. For example, the order of execution of the blocks may be changed, and/or some of the blocks described may be changed, eliminated, or combined.

As mentioned above, the example processes of FIGS. 6, 7, and/or 8 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and transmission media. As used herein, “tangible computer readable storage medium” and “tangible machine readable storage medium” are used interchangeably. Additionally or alternatively, the example processes of FIGS. 6, 7, and/or 8 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and transmission media. As used herein, when the phrase “at least” is used as the transition term in a preamble of a claim, it is open-ended in the same manner as the term “comprising” is open ended.

FIG. 6 is a flowchart representative of example machine-readable instructions 600 which may be executed to implement the example service provider 120 of FIG. 1. Execution of the example machine-readable instructions 600 of FIG. 6 begins with the example transcoder 122 of the service provider 120 receiving the media from the media provider 110 (block 610). In the illustrated example, the media is received as it is broadcast (e.g., live). However, in some examples, the media is stored and/or cached by the transcoder 122. The media is then transcoded by the transcoder 122 of the service provider 120 (block 620). In the illustrated example, the media is transcoded into a binary format (e.g., an MPEG4 transport stream) that may be transmitted via HTTP live streaming (HLS).

The media identifier 125 of the illustrated example then identifies the media (block 630). In the illustrated example, the example media identifier 125 operates on the transcoded media. However, in some examples, the example media identifier 125 operates on the media prior to transcoding. The media identifier 125 of the illustrated example identifies the media by extracting media identifying data (e.g., signatures, watermarks, etc.) from the media. Based on the extracted media identifying data, the media identifier 125 generates metadata (block 640). In the illustrated example, the metadata is generated using an ID3 formatted string. However, any other metadata format may additionally or alternatively be used. Further, in the illustrated example, the metadata is generated based on the extracted media identifying data. However, in some examples, the metadata may be generated by querying an external source using some or all of the extracted media identifying data.

The metadata inserter 135 of the service provider 120 embeds the metadata into the media (block 650). In the illustrated example, the metadata is converted into a binary format and inserted into the binary formatted media. In some examples, the metadata inserter 135 embeds a metadata start section as a prefix to the metadata and a metadata stop section as a suffix to the metadata.

The media is then transmitted by the media transmitter 140 of the service provider 120 (block 660). In the illustrated example, the media is transmitted using HTTP live streaming (HLS). However, any other format and/or protocol for transmitting (e.g., broadcasting, unicasting, multicasting, etc.) media may additionally or alternatively be used.

FIG. 7 is a flowchart representative of example machine-readable instructions which may be executed to implement the example media monitor of FIGS. 1 and/or 4. The example program 700 of the illustrated example of FIG. 7 begins when the example metadata processor 420 determines whether media presentation data should be gathered. (block 710). In the illustrated example, the example metadata processor 420 determines that media presentation data should be gathered when, for example, a webpage including monitoring instructions (e.g., the instructions of the example webpage of FIG. 5) is presented to a user (e.g., upon loading the webpage). However, any other approach to determining whether media presentation data should be gathered may additionally or alternatively be used. For example, the example metadata processor 420 may set a threshold timer to gather media presentation data periodically. Moreover, an aperiodic approach may be taken, where the example metadata processor 420 detects media presentation events (e.g., media is loaded for presentation, a user presses a play button, a frame of a video is advanced, etc.) If media presentation data is not to be gathered (block 710), the metadata processor 420 continues to determine whether media presentation data should be gathered (block 710).

If media presentation data is to be gathered (block 710) the example position determiner 405 determines a current position within the media (block 720). The example position determiner 405 determines the current position within the media by interacting with the media presenter 162. In the illustrated example, the position determiner 405 executes a JavaScript instruction to retrieve the current position from the media presenter 162. However, any other way of identifying a current position of media presentation within media may additionally or alternatively be used.

The example duration determiner 407 determines a duration of the media. (block 725) In the illustrated example, the duration determiner 407 determines the duration by querying the media presenter 162 for the duration of the media. However, any other approach to identifying a duration of media may additionally or alternatively be used such as, for example, processing a screenshot of the media presenter to identify a duration text (e.g., 5:06, representing media that is five minutes and six seconds in duration).

The example source determiner 410 interacts with the example media presenter 162 to identify a source of the media. (block 730). In the illustrated example, the source of the media is identified by a universal resource locator (URL). However, any other source descriptor may additionally or alternatively be employed (e.g., a name of the service provider 120, a name of the media provider 110, etc.) The example source determiner 410 retrieves the URL through the media presenter 162. In some examples, rather than interacting with the media presenter 162 (e.g., a QuickTime plugin of a browser), the example source determiner 410 is implemented using JavaScript instructions (e.g., the example JavaScript instructions of the example webpage of FIG. 5) to read a source of a media element (e.g., a hypertext markup language (HTML) video tag) of a webpage.

The example state determiner 415 interacts with the example media presenter 162 to identify a state of the media presentation. (block 740). In the illustrated example, the example state determiner 415 queries the media presenter 162 for the state of the media presentation. However, any other approach may additionally or alternatively be used such as, for example, processing an image of the media presenter to, for example, detect a presence of a play icon, a presence of a pause icon, etc.

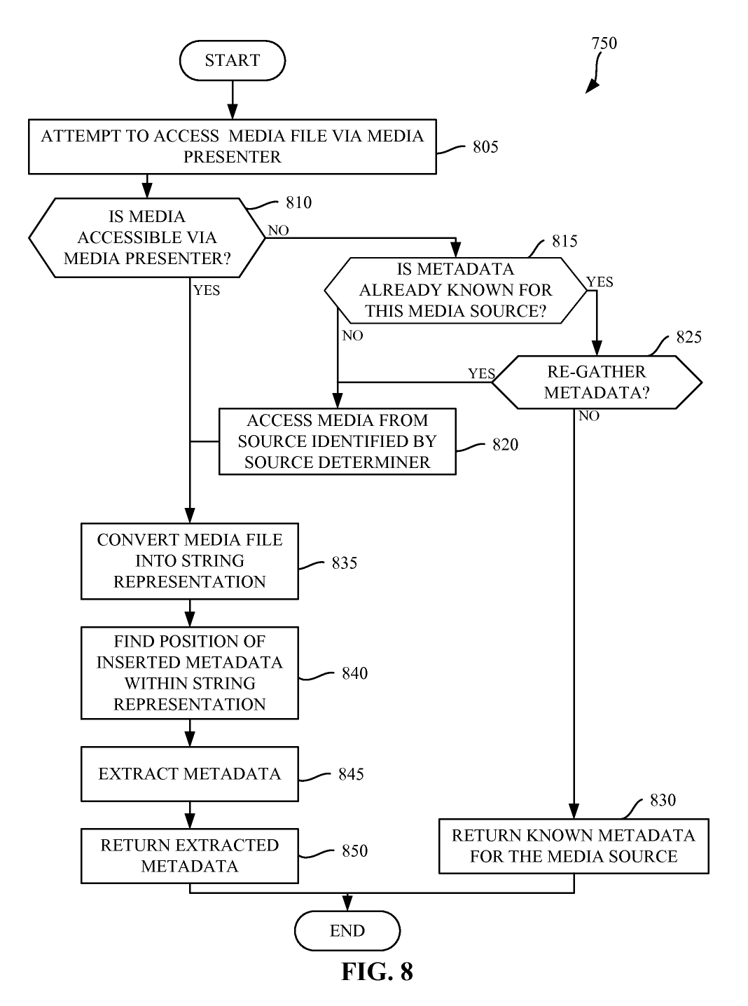

The example metadata processor 420 accesses metadata inserted in the media. (block 750). An example procedure for accessing the inserted metadata is described below in connection with FIG. 8. The inserted metadata is extracted and reported as part of the media presentation data.

The example timestamper 445 generates a timestamp indicative of a date and/or time that the media presentation data was gathered. (block 760). In the illustrated example, the timestamper 445 determines the date and/or time using a clock of the media device 160. However, in some examples, the timestamper 445 determines the data and/or time by requesting the date and/or time from an external time source, such as a National Institute of Standards and Technology (NIST) Internet Time Service (ITS) server. However, any other approach to determining a timestamp may additionally or alternatively be used.

The example transmitter 450 transmits the gathered media presentation data (e.g., the position information, the duration information, the source information, the state information, the inserted metadata, and a timestamp) to the central facility 170. (block 770) In the illustrated example, the media presentation data is transmitted to the central facility 170 using an HTTP Post request. However, any other method of transmitting data and/or metadata may additionally or alternatively be used. Because, in the illustrated example, an HTTP request is used, the transmitter 450 includes cookie data that identifies a user and/or a device that is transmitting the media presentation data. In some examples, the users are panelists and the user and/or device identifier conveyed by the cookie data is known and/or set by the central facility 170. The user and/or device identifier enables the central facility 170 to identify demographic information associated with the user and/or device. However, in some other examples, the users are not panelists and the demographic information is determined via other approaches, such as those described in Mazumdar, U.S. Pat. No. 8,370,489, which is hereby incorporated by reference in its entirety. As such, the central facility 170 can identify the user and/or the device as associated with the media presentation. While in the illustrated example an HTTP Post request is used, any other approach to transmitting data may additionally or alternatively be used.

FIG. 8 is a flowchart representative of example machine-readable instructions which may be executed to implement the example media monitor 165 of FIGS. 1 and/or 4. The example program 750 of the illustrated example of FIG. 8 implements block 750 of FIG. 7. At block 805, the example metadata processor 420 instructs the metadata accesser 425 to attempt to access a file representing the media via the media presenter 162. (block 805). In the illustrated example, the media accesser 425 interacts with the media presenter 162 to access the media via, for example, a buffer of the media presenter 162. However, not all media presenters reliably convey the media to the media accesser 425, and/or grant access to its buffer. As such, the example media accesser 425 determines whether the media is accessible via the media presenter 162. (block 810).

If the media is not accessible (block 810), the example media accesser 425 determines whether metadata is already known for the media. (block 815). In some examples, metadata may be stored in a cache accessible to the media monitor 165 prior to transmitting the metadata to the central facility 170. The cache may be inspected to determine whether metadata from a previous metadata extraction is available. Metadata may already be known for the media if, for example, the media was previously viewed using a different media presenter, the media presenter recently provided the media to the media accesser 425 but has since malfunctioned, etc. If metadata is already known for the media, the media accesser 425 determines whether the metadata should be re-gathered. (block 825). In some examples, the known metadata may not be current. That is, the known metadata may have been associated with media that was presented more than a threshold period of time ago (e.g., more than ten minutes ago, more than one day ago, etc.). If the metadata is current, the known metadata for the media source is returned as the media for the media source. (block 830).

If the metadata is (1) not known (block 815), or (2) known, but not current (block 825), the metadata is re-gathered. To this end, the example media accesser 425 of the illustrated example accesses the media from the source identified by the source determiner 410 (block 820). In such an implementation, the media may be transmitted to the media device 160 more than once. While such re-transmission does use additional bandwidth, because the media is transmitted using small HLS segments (e.g., three second segments), the effect of such re-transmission is negligible. Moreover, by determining whether the metadata is already known for the media source (block 815) and/or determining whether the metadata is current (block 825), the example media accesser 425 reduces the amount of bandwidth required by selectively requiring re-transmission only when necessary.

Once the media is accessed (e.g., via the media presenter 162 (block 810), via the source identified by the source determiner 410 (block 820), etc.), the example media converter 430 converts the media accessed by the media accesser 425 into a string representation. As described above, the media accesser 425 accesses the media in a binary format. However, the metadata embedded in the media is embedded in a text (e.g., string) format. In the illustrated example, the example media converter 430 converts the media from a binary format to a text format. In the illustrated example, the media converter 430 converts the binary data into a text format using an American Standard Code for Information Exchange (ASCII) format. However, any other format may additionally or alternatively be used.

The example metadata locator 435 inspects the text formatted media converted by the media converter 430. (block 840). In the illustrated example, the example metadata locator 435 inspects the text formatted media for a start location of a metadata tag. In the illustrated example, the start location of the metadata tag represents a character within the text formatted media where the metadata can be found. Referring to the example of FIG. 3, the example metadata locator 435 inspects the media for the characters “META” as the indication of the beginning of the metadata tag (e.g., the beginning of the metadata section 320). However, any other approach may additionally or alternatively be used such as, for example, the metadata locator 435 may inspect the media to identify the metadata start section 315, and/or the metadata stop section 325, the metadata locator 435 may use pattern matching to identify text that matches an expected format of the metadata (e.g., an ID3 tag format).

The example metadata extractor 440 extracts the metadata from the converted media based on the identified location of the metadata identified by the metadata locator 435. (block 845) In the illustrated example, the metadata is a fixed length (e.g., forty characters). As such, the example metadata extractor 440 extracts a string from the metadata starting from the start location and matching the predefined fixed length of the metadata. However, in some examples, the metadata is a variable length. In some examples, the example metadata extractor 440 determines a length of the metadata and extracts the metadata based on the identified length. The example metadata extractor 440 returns the extracted metadata to the metadata processor 420 for reporting via the transmitter 450 as part of the media presentation data. (block 850).

FIG. 9 is a block diagram of an example processor platform 120 structured to execute the instructions of FIG. 6 to implement the example service provider 120 of FIG. 1. The processor platform 120 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 120 of the illustrated example includes a processor 912. The processor 912 of the illustrated example is hardware. For example, the processor 912 can be implemented by one or more integrated circuits, logic circuits, microprocessors, or controllers from any desired family or manufacturer.

The processor 912 of the illustrated example includes a local memory 913 (e.g., a cache), and executes instructions to implement the example transcoder 122, the example media identifier 125, and the example metadata inserter 135. The processor 912 of the illustrated example is in communication with a main memory including a volatile memory 914 and a non-volatile memory 916 via a bus 918. The volatile memory 914 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 916 may be implemented by flash memory and/or any other desired type of memory device. Access to the main memory 914, 916 is controlled by a memory controller.

The processor platform 120 of the illustrated example also includes an interface circuit 920. The interface circuit 920 may be implemented by any type of interface standard, such as an Ethernet interface, a universal serial bus (USB), and/or a PCI express interface.

In the illustrated example, one or more input devices 922 are connected to the interface circuit 920. The input device(s) 922 permit(s) a user to enter data and commands into the processor 912. The input device(s) can be implemented by, for example, an audio sensor, a microphone, a camera (still or video), a keyboard, a button, a mouse, a touchscreen, a track-pad, a trackball, and/or a voice recognition system.

One or more output devices 924 are also connected to the interface circuit 920 of the illustrated example. The output devices 924 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 920 of the illustrated example, thus, typically includes a graphics driver card, a graphics driver chip or a graphics driver processor.

The interface circuit 920 of the illustrated example also includes a communication device such as a transmitter, a receiver, a transceiver, a modem and/or network interface card to facilitate exchange of data with external machines (e.g., computing devices of any kind) via a network 926 (e.g., an Ethernet connection, a digital subscriber line (DSL), a telephone line, coaxial cable, a cellular telephone system, etc.). The interface circuit 920 implements the example media transmitter 140.

The processor platform 120 of the illustrated example also includes one or more mass storage devices 928 for storing software and/or data. Examples of such mass storage devices 928 include floppy disk drives, hard drive disks, compact disk drives, Blu-ray disk drives, RAID systems, and digital versatile disk (DVD) drives.

The coded instructions 932 of FIG. 6 may be stored in the mass storage device 928, in the volatile memory 914, in the non-volatile memory 916, and/or on a removable tangible computer readable storage medium such as a CD or DVD.

FIG. 10 is a block diagram of an example processor platform 160 structured to execute the instructions of FIGS. 7, and/or 8 to implement the example media monitor 165 of FIGS. 1 and/or 4. The processor platform 160 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 160 of the illustrated example includes a processor 1012. The processor 1012 of the illustrated example is hardware. For example, the processor 1012 can be implemented by one or more integrated circuits, logic circuits, microprocessors, or controllers from any desired family or manufacturer.

The processor 1012 of the illustrated example includes a local memory 1013 (e.g., a cache), and executes instructions to implement the example position determiner 405, the example duration determiner 407, the example source determiner 410, the example state determiner 415, the example metadata processor 420, the example media accesser 425, the example media converter 430, the example metadata locator 435, the example metadata extractor 440, and the example timestamper 445. The processor 1012 of the illustrated example is in communication with a main memory including a volatile memory 1014 and a non-volatile memory 1016 via a bus 1018. The volatile memory 1014 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1016 may be implemented by flash memory and/or any other desired type of memory device. Access to the main memory 1014, 1016 is controlled by a memory controller.

The processor platform 160 of the illustrated example also includes an interface circuit 1020. The interface circuit 1020 may be implemented by any type of interface standard, such as an Ethernet interface, a universal serial bus (USB), and/or a PCI express interface.

In the illustrated example, one or more input devices 1022 are connected to the interface circuit 1020. The input device(s) 1022 permit(s) a user to enter data and commands into the processor 912. The input device(s) can be implemented by, for example, an audio sensor, a microphone, a camera (still or video), a keyboard, a button, a mouse, a touchscreen, a track-pad, a trackball, and/or a voice recognition system.

One or more output devices 1024 are also connected to the interface circuit 1020 of the illustrated example. The output devices 1024 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 1020 of the illustrated example, thus, typically includes a graphics driver card, a graphics driver chip or a graphics driver processor.

The interface circuit 1020 of the illustrated example also includes a communication device such as a transmitter, a receiver, a transceiver, a modem and/or network interface card to facilitate exchange of data with external machines (e.g., computing devices of any kind) via a network 1026 (e.g., an Ethernet connection, a digital subscriber line (DSL), a telephone line, coaxial cable, a cellular telephone system, etc.). The interface circuit 920 implements the example transmitter 450.

The processor platform 160 of the illustrated example also includes one or more mass storage devices 1028 for storing software and/or data. Examples of such mass storage devices 1028 include floppy disk drives, hard drive disks, compact disk drives, Blu-ray disk drives, RAID systems, and digital versatile disk (DVD) drives.

The coded instructions 1032 of FIGS. 7 and/or 8 may be stored in the mass storage device 1028, in the volatile memory 1014, in the non-volatile memory 1016, and/or on a removable tangible computer readable storage medium such as a CD or DVD.

From the foregoing, it will be appreciated that methods, apparatus and articles of manufacture have been disclosed which enable measurement of exposure to streaming media. Example approaches disclosed herein enable collection of media presentation data upon loading of the media. These example approaches are beneficial over prior known systems because they enable detection of media that is not yet presented, as compared to detecting media once it is presented (e.g., after presentation begins). This is useful because, for example, it enables monitoring of media that was available for presentation to a user, but the user did not begin presentation.

Moreover, example methods, apparatus, and articles of manufacture disclosed herein reduce processing requirements as compared with known systems for accessing metadata associated with media. Some known systems for accessing media identifying information at a consumer's media device require the consumer's media device to process the media to extract a code, signature, watermark, etc. from the media itself. Such extraction is a processor intensive task which consumes time, battery power, etc., and when performed by a media device with limited processing resources potentially causes the consumer's device to perform poorly. Accessing the metadata by converting the media from a binary to a string format reduces the processing requirements of the consumer media device, thereby reducing the amount of time, battery power, etc. consumed by the monitoring efforts of the media device. Such reduced processing requirements enhance battery life because less processing power is required to operate the media device to monitor media.

Some other known systems require the media device to access metadata supplied with media by, for example, inspecting a timed text track, inspecting a metadata channel of the media, inspecting an encryption key of the media, etc. However, access to such metadata is not implemented consistently across various platforms (e.g., different operating systems, different browsers, etc.). For some platforms, access to such information (e.g., via a metadata channel, via a timed text track, etc.) is prohibited. The example methods, apparatus, and articles of manufacture disclosed herein present a cross-platform approach, as JavaScript instructions are reliably executed by a large variety of different media devices. Implementing monitoring instructions as JavaScript instructions results in a wider range of users who may be monitored, including users who are not panelists. Monitoring users who are not panelists further results in less missed instances where media monitoring would occur.

Moreover, the example methods, apparatus, and articles of manufacture disclosed herein, while attempting to interface with an Application Programming Interface (API) of a media presenter (e.g., a QuickTime plugin of a browser), is not reliant on such access. As disclosed above, when the media monitor detects that access to the media is not granted (e.g., the QuickTime plugin does not grant access to the media), the example media monitor may re-download the media for metadata analysis. Moreover, in some examples, the media monitor determines whether the metadata for the media to be re-downloaded is already known. In such an example, bandwidth requirements of the media device are reduced because the media monitor does not re-download media unless the metadata associated with the media is unknown. Such an approach is not reliant on the media presenter (e.g., QuickTime, Flash, etc.), and ensures that media presentations are reliably monitored. Because less instances where media monitoring would occur are missed (i.e., more instances are monitored), less projection and/or extrapolation is required to prepare reports about the media. These reduced projections and/or extrapolations result in reduced processing and/or memory requirements of the central facility that crates the reports.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. A method of measuring exposure to streaming media, the method comprising:
accessing, with a processor, media received from a service provider at a media device, the media formatted using a binary format;
converting, with the processor, the media into a text-formatted media;
locating a position of inserted metadata within the text-formatted media;
extracting the inserted metadata from the text-formatted media using the located position; and
transmitting the extracted metadata to a central facility.

2. The method as described in claim 1, wherein the media is accessed by interacting with a media presenter of the media device.

3. The method as described in claim 2, wherein the media is accessed by retrieving the media from a media buffer accessible to the media presenter.

4. The method as described in claim 1, wherein accessing the media further comprises determining a source of the media, and requesting the media from the source.

5. The method as described in claim 4, wherein the source of the media identified by is a Universal Resource Locator.

6. The method as described in claim 1, wherein the metadata is formatted using an ID3 format.

7. The method as described in claim 1, wherein the position is located by detecting a metadata start section within the text-formatted media.

8. The method as described in claim 1, wherein the position is located by detecting a pattern of text matching an ID3 format.

9. The method as described in claim 1, wherein the position is located by detecting a start character within the text-formatted media.

10. (canceled)

11. The method as described in claim 1, further comprising transmitting at least one of a user identifier or a device identifier to the central facility.

12. An apparatus to measure exposure to streaming media, the apparatus comprising:
a media accesser to access binary-formatted media received from a service provider at a media device;
a media converter to convert the binary-formatted media into text-formatted media;
a metadata locator to locate a position of metadata within the text-formatted media;
a metadata extractor to extract the metadata from the text-formatted media based on the located position; and
a transmitter to transmit the metadata to a central facility.

13. The apparatus as described in claim 12, further comprising a position determiner to determine a position of playback within the media, the transmitter to transmit the position of playback to the central facility.

14. The apparatus as described in claim 12, further comprising a duration determiner to determine a duration of the media, the transmitter to transmit the duration of the media to the central facility.

15. The apparatus as described in claim 12, further comprising a source determiner to determine a source of the media.

16. (canceled)

17. (canceled)

18. The apparatus as described in claim 15, wherein the media accesser is to determine whether the media can be accessed via a media presenter of the media device, and, if the media is not accessible via the media presenter, to access the media via the source of the media.

19. The apparatus as described in claim 18, wherein the media accesser is to reduce a bandwidth requirement of the apparatus by determining whether metadata is known in association with the media and not accessing the media via the source of the media when the metadata is known in association with the media.

20. (canceled)

21. (canceled)

22. A tangible machine-readable storage medium comprising instructions which, when executed, cause a machine to at least:
access media received from a service provider at a media device, the media formatted using a binary format;
convert the media into a text-formatted media;
locate a position of inserted metadata within the text-formatted media;
extract the inserted metadata from the text-formatted media using the located position; and
transmit the extracted metadata to a central facility.

23-26. (canceled)

27. The tangible machine-readable medium as described in claim 22, wherein the metadata is formatted using an ID3 format.

28. The tangible machine-readable medium as described in claim 22, wherein the instructions cause the machine to locate the position by detecting a metadata start section within the text-formatted media.

29. The tangible machine-readable medium as described in claim 22, wherein the instructions cause the machine to locate the position by detecting a pattern of text matching an ID3 format.

30-32. (canceled)
